(19) United States
(12) Patent Application Publication
(10) Pub. No.: US 2010/0136455 A1
(43) Pub. Date: Jun. 3, 2010

(54) Common Module Stack Component Design

(76) Inventor: Rick Winter, Orinda, CA (US)

Correspondence Address: HAYNES AND BOONE, LLP;IP Section, 2323 Victory Avenue, Suite 700, Dallas, TX, 75219, US

(21) Appl. No.: 12/577,134

(22) Filed: Oct. 9, 2009

Related U.S. Application Data
(60) Provisional application No. 61/104,581, filed on Oct. 10, 2008.

(51) Int. Cl. H01M 8/04; H01M 8/02

(52) U.S. Cl. 429/458; 429/452

(57) ABSTRACT

A stack for use in a flow battery, the stack comprising an odd number of interior elements positioned between two end elements, the two end elements each including an electrode, and the odd number of interior elements including membrane elements alternating with electrode elements, wherein the membrane elements include an interior frame and a membrane, the electrode elements include the interior frame and an electrode, wherein the interior frame is rotated by 180° from the frame of the membrane elements.

### CROSS-REFERENCE TO RELATED APPLICATIONS

The present application claims benefit under 35 U.S.C. §119(e) of U.S. Provisional Application No. 61/104,581 filed on Oct. 10, 2009, entitled “Common Module Stack Component Design,” the content of which is hereby incorporated by reference.

### BACKGROUND

1. Technical Field

This invention relates to flow battery systems, and more specifically, a method and design for building flow battery stacks.

2. Discussion of Related Art

Flow batteries store electrical energy in a chemical form, and subsequently dispense the stored energy in an electrical form via a spontaneous reverse redox reaction. As such, a flow battery is an electrochemical storage device in which an electrolyte containing one or more dissolved electro-active species flows through a reactor cell where chemical energy is converted to electrical energy. Conversely, the discharged electrolyte can be flowed through a reactor cell and electrical energy converted to chemical energy. Electrolyte is stored externally, for example in tanks, and flowed through a set of cells where the electrochemical reaction takes place. Externally stored electrolytes can be flowed through the battery system by pumping, gravity feed, or by any other method of moving fluid through the system. The reaction in a flow battery is reversible. The electrolyte can be recharged without replacing the electroactive material.

The minimal unit that performs the electrochemical energy conversion is generally called a “cell,” whether in the case of flow batteries, fuel cells, or secondary batteries. A device that integrates many such cells, coupled electrically in series and/or parallel, to get higher current, voltage or both, is generally called a “battery.” However, it is common to refer to any collection of coupled cells, including a single cell used on its own, as a battery. As such, a single cell can be referred to interchangeably as a “cell” or a “battery.”

Flow batteries can be utilized in many technologies that require the storage of electrical energy. For example, flow batteries can be utilized for storage of night-time electricity that is inexpensive to produce to provide electricity during peak demand when electricity is more expensive to produce or demand is beyond the capability of current production. Such batteries can also be utilized for storage of green energy (i.e. energy generated from renewable sources such as wind, solar, wave, or other non-conventional sources).

Many devices that operate on electricity are adversely affected by the sudden removal of their power supply. Flow batteries can be utilized as uninterruptible power supplies in place of more expensive backup generators. Efficient methods of power storage can provide for devices to have a built-in backup that mitigates the effects of power cuts or sudden power failures. Power storage devices can also reduce the impact of a failure in a generating station. Other situations where uninterruptible power supplies can be of importance include, but are not limited to, buildings where uninterrupted power is critical such as hospitals. Such batteries can also be utilized for providing an uninterruptible power supply in developing countries, many of which do not have reliable electrical power sources resulting in intermittent power availability.

The flow cell operates by changing the oxidation state of its constituents during charging or discharging. The basic flow cell includes two half-cells connected in series by the conductive electrolyte, one for anodic reaction and the other for cathodic reaction. Each half-cell includes an electrode with a defined surface area upon which the redox reaction takes place. Electrolyte flows through the half-cell as the redox reaction takes place. The two half-cells are separated by an ion-exchange membrane (IEM) where either positive ions or negative ions pass through the membrane. Multiple such cells can be electrically coupled (e.g., “stacked”) in series to achieve higher voltage, in parallel in order to achieve higher current, or both. The reactants are stored in separate tanks and dispensed into the cells as necessary in a controlled manner to supply electrical power to a load.

Conventional flow battery stack designs can involve the use of a plurality of different types of specialized components. These components may require many dedicated production tools and can cause an increase in production cost and complexity. Furthermore, the integration of these various types of components into a flow battery stack can increase the number of potential failure points that can reduce the efficiency of a flow battery. There is, therefore, a need for an improved flow battery stack design that can reduce production cost and complexity without reducing the efficiency of a flow battery.

### SUMMARY

Consistent with some embodiments of the present invention, a stack for use in a flow battery includes an odd number of interior elements positioned between two end elements, the two end elements each including an electrode, and the odd number of interior elements including membrane elements alternating with electrode elements, wherein the membrane elements include an interior frame and a membrane, the electrode elements include the interior frame and an electrode, wherein the interior frame is rotated by 180° from the frame of the membrane elements.

A method for assembling a stack for use in a flow battery consistent with the present invention includes assembling two end elements, the two end elements each including an electrode; assembling membrane elements, the membrane elements each including a membrane bonded to a membrane frame, assembling electrode elements, the electrode elements each including an electrode bonded to an electrode frame, both the membrane frame and the electrode frame being identical interior frames; positioning the interior elements between the two end elements with membrane elements alternating with electrode elements and with membrane frames positioned opposite by a rotation of 180° from electrode frames; and coupling the stack together.

These and other embodiments of the invention are further described below with respect to the following figures.

### BRIEF DESCRIPTION OF THE DRAWINGS

In order to more fully understand the present invention, reference is made to the accompanying drawings, with the understanding that these drawings are not intended to limit the scope of the invention.

FIG. 1 illustrates a flow battery that is consistent with some embodiments of the present invention.

FIG. 2 is another illustration of a flow battery that is consistent with some embodiments of the present invention.

FIG. 3 illustrates a flow battery stack that is consistent with some embodiments of the present invention.

FIGS. 4a, 4b and 4c illustrate components of a flow battery stack that are consistent with some embodiments of the present invention.

FIG. 5 illustrates an assembled flow battery stack that is consistent with some embodiments of the present invention.

In the figures, elements having the same designation have the same or substantially similar function. The figures are illustrative only and relative sizes and distances depicted in the figures are for convenience of illustration only and have no further meaning.

### DETAILED DESCRIPTION

A flow cell is the minimal component of a flow battery. Multiple flow cells can be coupled (e.g., “stacked”) to form a multi-cell battery. The cell includes two half-cells, each with an electrode, separated by a membrane, through which ions are transferred during a reduction-oxidation (redox) reaction. One half-cell contains the anolyte and the other half-cell contains the catholyte. The electrolytes (i.e., anolyte and catholyte) are flowed through the half-cells, often with an external pumping system. Electrodes in each half cell provide surfaces on which the redox reaction takes place and from which charge is transferred.

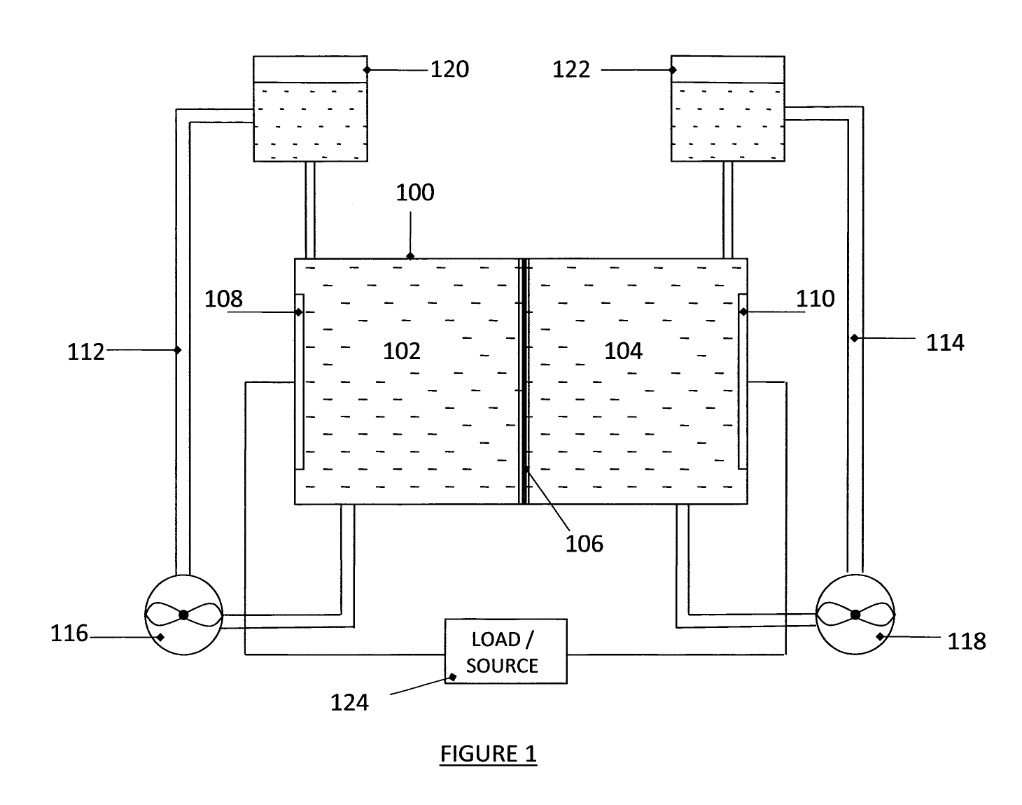

FIG. 1 illustrates a flow cell 100 consistent with some embodiments of the present invention. Flow cell 100 includes two half-cells 102 and 104 separated by an ion exchange membrane (IEM) 106. Half-cells 102 and 104 include electrodes 108 and 110, respectively, in contact with an electrolyte 130 and 132, respectively, such that an anodic reaction occurs at the surface of one of electrodes 108 or 110 and a cathodic reaction occurs at the surface of the other one of electrodes 108 or 110. Electrolyte 130 and 132 flows through each of half-cells 102 and 104 as a redox reaction takes place.

As shown in FIG. 1, the electrolyte 130 in half-cell 102 may be pumped through pipe 112 by pump 116 to holding tank 120. Similarly, the electrolyte 132 in half-cell 104 can be pumped through pipe 114 by pump 118 to holding tank 122. In some embodiments, holding tank 120 and 122 may segregate electrolyte that has flowed through cell 100 from electrolyte that has not. However, mixing discharged or partially discharged electrolyte may also be performed.

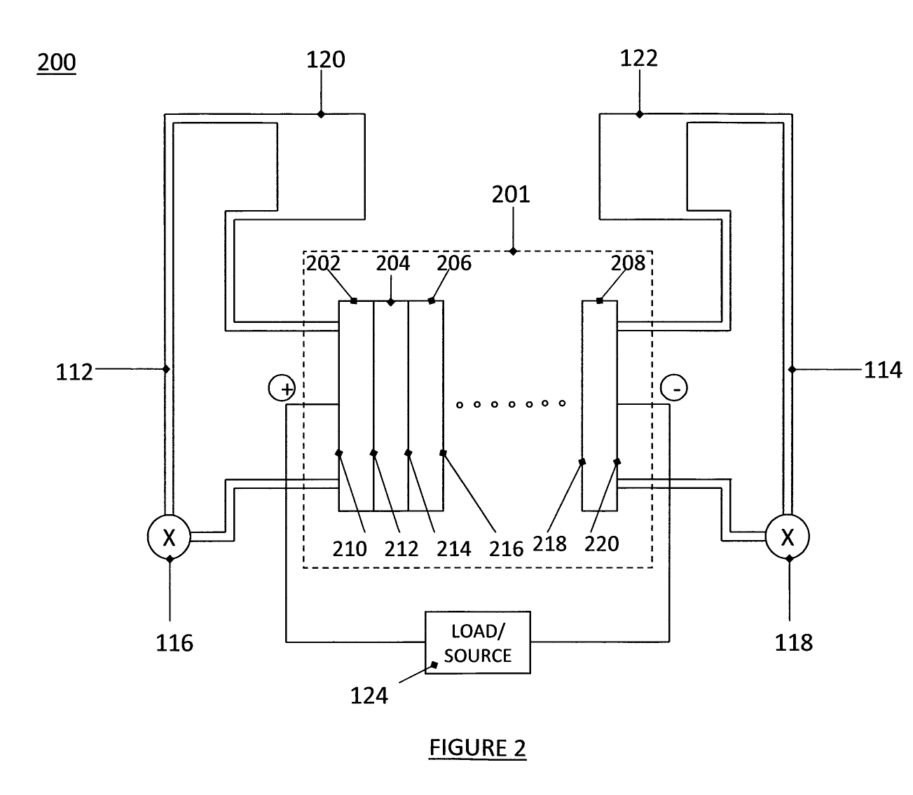

Electrodes 108 and 110 can be coupled to either supply electrical energy or receive electrical energy from load or source 124. Other monitoring and control electronics, included in load 124, can control the flow of electrolyte through half-cells 102 and 104. Multiple ones of cells 100 can be electrically coupled (e.g., “stacked”) in series to achieve higher voltage and/or in parallel in order to achieve higher current. FIG. 2 illustrates one such stacked arrangement of a flow battery 200 that is consistent with some embodiments of the present invention.

As illustrated in FIG. 2, in some embodiments flow battery 200 can include a stack 201. Stack 201 can further include a plurality of half-cells, such as, for example half-cells 202, 204, 206, and 208. End half-cells 202 and 208 can be coupled across load/source 124. FIG. 2 shows that there may be any even number of half cells, and thus any number of cells, in battery 200.

As further shown in FIG. 2, each of half cells 202, 204, 206, and 208 is formed between pairs of elements 210, 212, 214, 216, 218, and 220. In FIG. 2, for example, half cell 202 is formed by elements 210 and 212; half cell 204 is formed by elements 212 and 214; half cell 206 is formed by elements 214 and 216; and half cell 208 is formed by elements 218 and 220. In a two cell embodiment, element 218 and element 216 are the same. In a single cell embodiment, cells 204 and 206 would be absent and element 218 and 212 would be the same. Elements 210 and 220 form end plates and each includes electrodes. End plate electrodes are further discussed in U.S. application Ser. No. 12/576,235, entitled “Magnetic Current Collector,” filed on Oct. 8, 2009, assigned to the same entity, which is herein incorporated by reference in its entirety. In forming the remainder of battery 200, element 212 includes a membrane; element 214 includes an electrode; element 216 includes a membrane; and element 218 includes a membrane. In such fashion, multi-cell battery 200 is formed.

Further, electrolyte from tank 120 flows through half cells 202 and 206 while electrolyte from tank 122 flows through half cells 204 and 208. Elements 210, 212, 214, 216, 218, and 220, therefore, each includes either a membrane or an electrode, and controls the flow of the appropriate electrolyte into half cells 202, 204, 206, and 208.

In some embodiments, elements 210 and 220 of end half-cells 202 and 208, respectively, each include a pre-molded frame and an end-plate assembly that includes an electrode. In some embodiments, elements 210 and 220 can be structurally similar, but oriented opposite of each other, as is further discussed below. Consistent with embodiments of the present invention, elements 212, 214, 216, and 218 all include frames that are structurally identical, with either a membrane or an electrode attached to the frame.

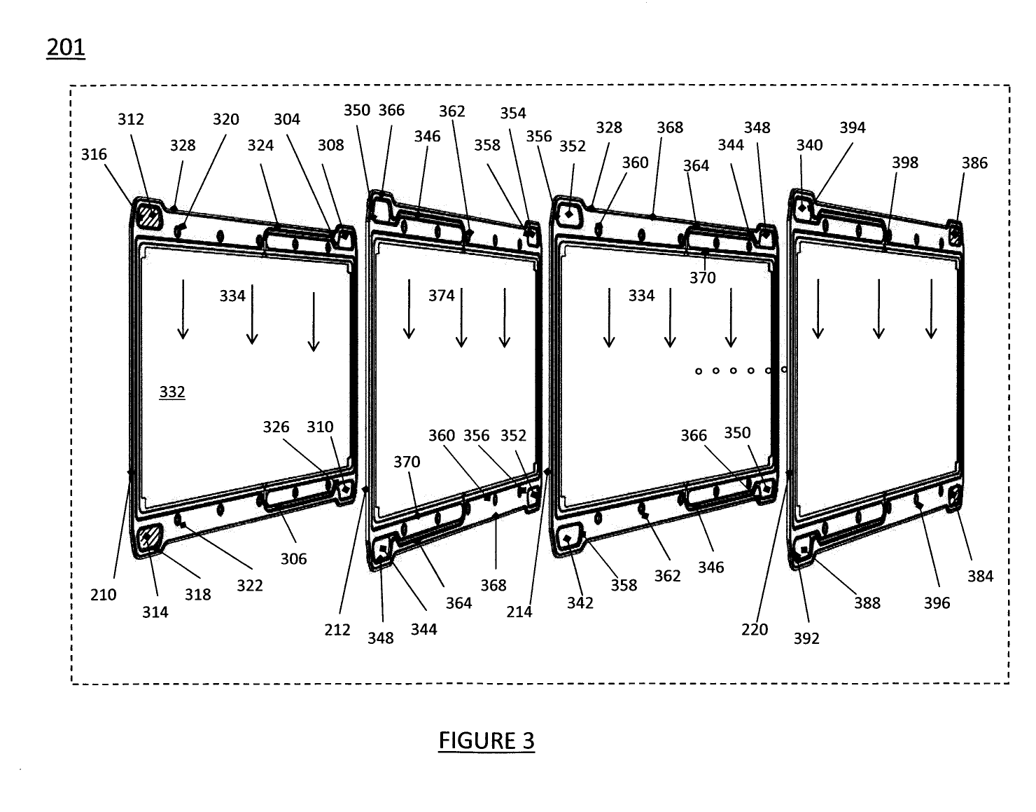

FIG. 3 illustrates a stack 201 consistent with some embodiments of the present invention. As illustrated in FIG. 2, stack 201 includes elements 210, 212, 214, and 220. When assembled, elements 210, 212, 214, and 220 are pressed together to form stack 201. As can be seen in FIG. 3, stack 201 can include end elements 210 and 220 and inner elements 212 and 214. For convenience, elements 216 and 218 are omitted. Generally, any number of elements can be utilized to form a battery stack having any number of cells. For convenience only, directions towards element 210 will be designated left while directions towards element 220 will be designated right.

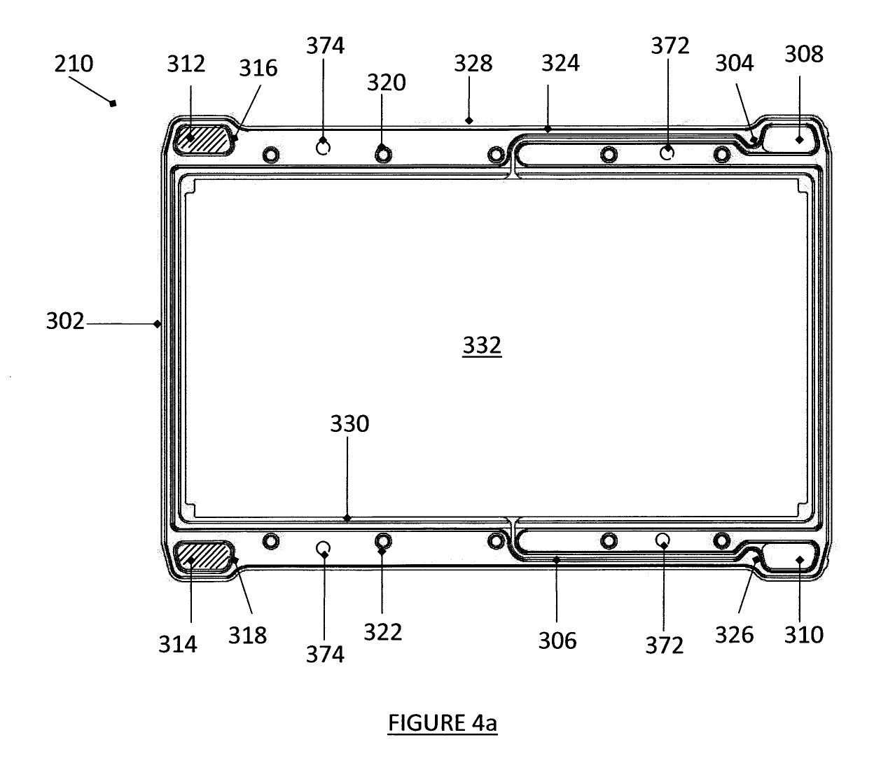

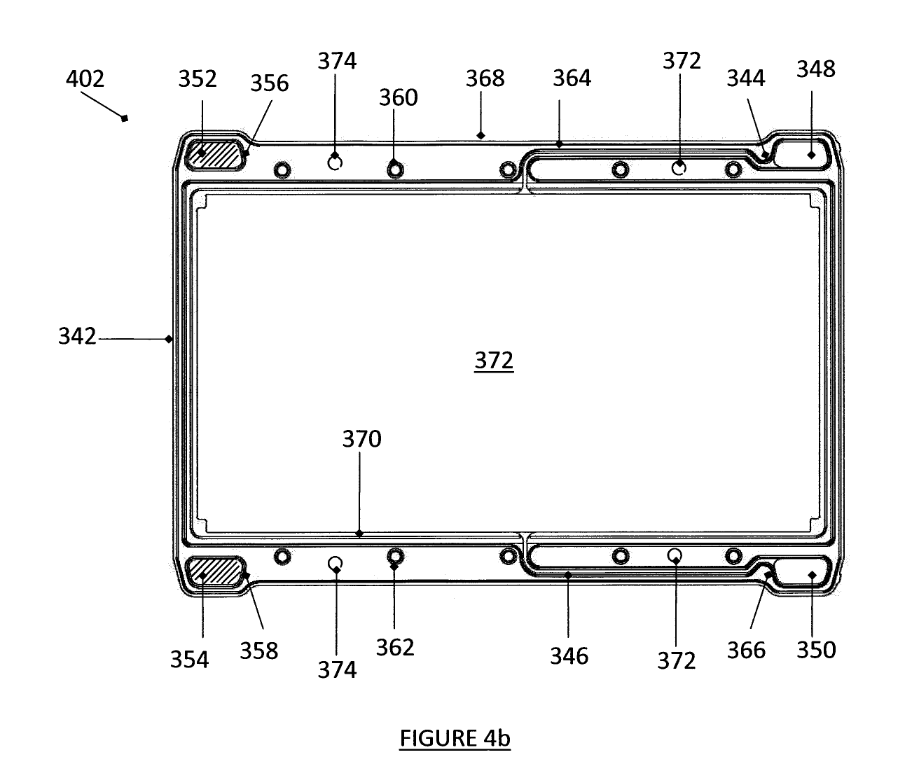

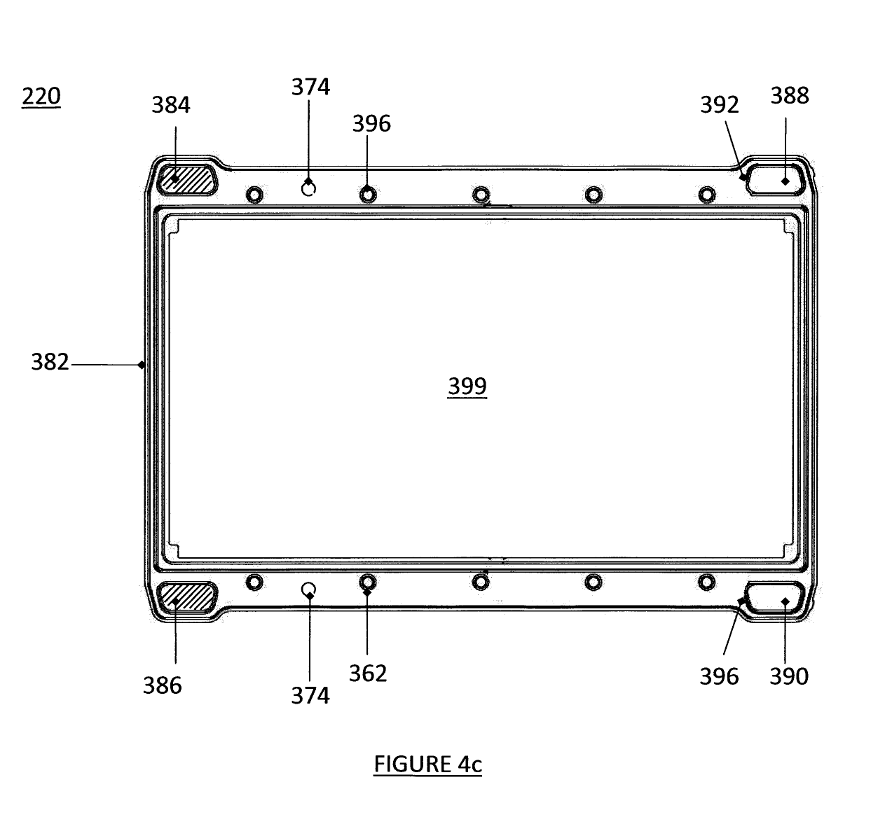

FIG. 4a illustrates an embodiment of element 210 consistent with the present invention. Element 210 is formed from frame 302 on which an electrode 332 is mounted. Because element 210 is an end element, electrode 332 also includes a terminal such as that disclosed in U.S. patent application Ser. No. 12/576,235, which was incorporated by reference above. Electrode 332 can be, for example, a conducting polymer or plastic material, such as a carbon infused plastic. Electrode 332 is rigidly attached to frame 302, for example, by bonding. Frame 302 can be, for example, a pre-molded plastic frame.

Frame 302 includes electrolyte openings 308 and 310. Electrolyte can, for example, be flowed into electrolyte opening 308 and flowed out of electrolyte opening 310, as is further discussed below. In some embodiments, a fitting may be attached to the left side of frame 302 to allow for the flow of electrolyte through electrolyte openings 308 and 310. A flow channel 324, which is a trench formation formed in frame 302, is coupled to electrolyte opening 308 to allow the flow of electrolyte onto electrode 332. A flow channel 306 is coupled to electrolyte opening 310 to allow for the flow of electrolyte from electrode 332. As shown in FIG. 3, an electrolyte flow field 334 is formed across electrolyte 332 between flow channel 304 and flow channel 306.

Frame 302 also includes plugs 312 and 314. Plugs 312 and 314 form the ends of a manifold in stack 201 for the electrolyte that is not flowed through the manifold formed by electrolyte openings 308 and 310. The manifolds formed by assembly of elements 210, 212, 214, and 220 will be further discussed below.

Frame 302 further includes a harness 320 and a harness 322. In the embodiment shown in FIG. 4a, harness 320 and harness 322 are formed by through-holes in frame 302. Stack 201 can be rigidly assembled with threaded rods run through harnesses 320 and 322. Pressure can also be applied between elements 210, 212, 214, and 220 utilizing the threaded rods. However, harnesses 320 and 322 can include any device for rigidly holding frame 302 in stack 201.

Channels 304 and 306, electrolyte openings 308 and 310, plugs 312 and 314, and frame 302 are sealed against element 212 in stack 201 by, for example, o-ring type seals. The left side of element 212 is flat in order to accommodate the seals formed in frame 302. A trench, with a rubber sealing material, is formed around channel 304 to form seal 324. A trench, with a rubber sealing material, is also formed around channel 306 to form seal 326. In the embodiment shown in FIG. 4a, seal 324 and seal 326 are contiguously formed in that the trench and rubber sealing material is formed around the entire circumference of frame 302. A seal 316 is similarly formed around plug 312. Also, a seal 318 is formed around plug 314. A further trench filled with rubber sealing material is formed around the entire outer circumference of frame 302 to form seal 328. Each of seals 328, 324, 326, 316, and 318 forms a seal against a flat side of element 212 once element 212 is compressed against element 210. As discussed above, half-cell 202 is formed between element 210 and 212.

FIG. 4b illustrates an inner element 402, which can be any of the inner elements between elements 210 and 220. Inner elements 212 and 214 are shown in FIG. 3, however there may be any odd number of inner elements in stack 201 to form a battery with integer number of cells.

Inner element 402 includes a frame 342 onto which a battery component 372 is mounted. Battery component 372 can be an electrode or a membrane. As discussed above, an electrode can be formed from a conducting polymer or plastic material, such as a carbon infused plastic. A membrane may be a porous membrane as described in U.S. application Ser. No. 12/217,059, filed on Jul. 1, 2008, and assigned to the same entity as is the current disclosure, which is herein incorporated by reference in its entirety. Battery component 372 is bonded to frame 342. In the case of a porous membrane, bonding can be accomplished as described in {Attorney docket no. 43610.40} entitled “Solvent Welding Technique,” concurrently filed with the present application, which is herein incorporated by reference in its entirety.

As above, frame 342 can be a pre-molded plastic frame. Frame 342 is flat on the side opposite that shown in FIG. 4b (the left side). Further, frame 342 includes electrolyte openings 348 and 350, to which channels 344 and 346 are coupled in order to flow electrolyte over battery component 372. Frame 342 also includes electrolyte openings 352 and 354, through which electrolyte can pass but no electrolyte from electrolyte openings 352 and 354 is diverted by frame 342. Harnesses 360 and 362 allow for rigidly fixing frame 342 in stack 201. As shown in FIG. 4b, harness 360 and harness 362 include through-holes that align with harness 320 and 322 of element 210.

Frame 342 further includes seals in order to keep electrolyte that is present at electrolyte openings 348 and 350 from mixing with electrolyte that is present at electrolyte openings 352 and 354 as well as not allowing electrolyte to leak from stack 201 once stack 201 is fully assembled and compressed. Seal 364, which can be formed by a rubber material within a trench formed in frame 342, surrounds electrolyte opening 348 and channel 344. Seal 366 surrounds electrolyte opening 350 and channel 346. As before, seals 364 and 366 may be contiguously formed and hence extend around the inner perimeter of frame 342. A seal 368 is formed around the outer perimeter of frame 342. Seal 356 is formed around electrolyte opening 352 and seal 358 is formed around electrolyte opening 354. As discussed above, seals can be formed by placing a rubber gasket material (o-ring material) within a trench formed in frame 342.

FIG. 4c illustrates an embodiment of element 220, which again is an end plate for stack 201. Element 220 includes a frame 382 on which an electrode 399 is attached. Again, frame 382 can be formed of molded plastic and electrode 399 can be a conducting polymer or plastic that is bonded to frame 382. Because element 220 is an end point, a terminal can be formed in electrode 399 that is similar to that formed in electrode 322 of element 210. Again, the side of frame 382 opposite to that shown in FIG. 4c (the left side) is flat so that a seal can be formed when frame 382 is compressed against the next interior frame (not shown in FIG. 3). Frame 382 further includes electrolyte openings 388 and electrolyte openings 390, to which plumbing fixtures can be attached to allow electrolyte to flow through electrolyte openings 388 and 390. Seals 392 and 394 may be formed in frame 382 in order to seal against the plumbing fixtures. Further, frame 382 includes plugs 384 and 386. No further seals need to be included in frame 382, however, frame 382 shown in FIG. 4c may be nearly structurally identical with frame 302 of element 210. The major difference is the lack of channels, shown as channels 304 and 306, in frame 302. However, in manufacturing, frame 382 may be identical with frame 302, rotated by 180° when positioned in stack 201, with channels 304 and 306 filled with a sealing epoxy or other substance.

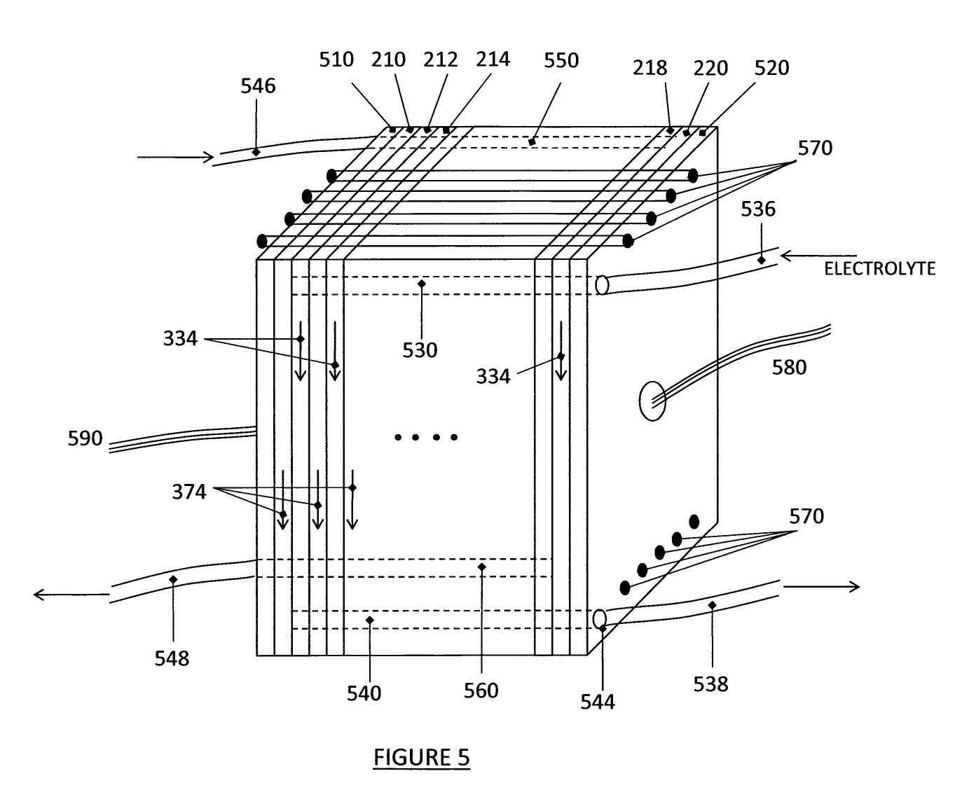

FIG. 5 illustrates a fully assembled embodiment of stack 201. Electrolyte is flowed through stack 201 through manifolds 530, 540, 550, and 560 created by electrolyte openings in each of elements 210 through 220. For example, a first electrolyte (i.e., either the catholyte or the anolyte) may pass through manifold 550, which is formed by electrolyte opening 308 of frame 302, electrolyte opening 354 of frame 342 of element 212, electrolyte opening 348 of frame 342 of element 214, and other similarly situated openings in interior elements. Plug 386 of frame 382 of element 220 seals manifold 550 in stack 201. A return manifold 560 for the first electrolyte, after passing through half cell 202, 208, and other similar half-cells in stack 201, for example, is created by electrolyte opening 310 of frame 302, electrolyte opening 352 of frame 342 of element 212, electrolyte opening 350 of frame 342 of element 212, and other similarly situated electrolyte openings in interior elements. Manifold 560 is plugged by plug 384 of frame 382 of element 220. Electrolyte can be fed into manifold 550, flowed through flow field 374, and through manifold 560 by plumbing fittings sealed against electrolyte openings 308 and 310 openings.

The second electrolyte (i.e., either the anolyte or the catholyte, depending on the nature of the first electrolyte) enters stack 201 at electrolyte opening 390 of frame 382 of element 220 and exits stack 201 at electrolyte opening 392 of frame 382 of element 220, after passing through elements such as element 212 in flow field 334. Manifold 530 is created by electrolyte opening 390 of frame 382 of element 220, electrolyte opening 356 of frame 342 of element 214, electrolyte opening 350 of frame 342 of element 212, and all other similarly situated electrolyte openings. Manifold 530 is plugged by plug 312 of frame 302 of element 210. Manifold 540, which can be a return manifold, is created by electrolyte opening 388 of frame 382 of element 220, electrolyte opening 354 of frame 342 of element 214, electrolyte opening 348 of frame 342 of element 212, and other similarly oriented electrolyte openings. Manifold 540 is plugged by plug 314 of frame 302 of element 210.

Manifold 550 may be coupled with storage tank 120 via pipe 112 through electrolyte openings 308 and 310. Pump 116 can be used to pump electrolyte through a flow field 334 of end frame 302 such that electrolyte can enter flow field 334 via distribution channel 304 (from opening 308 in frame 302) and electrolyte can be collected from flow field 334 through manifold 560, partly through collection channel 306 (through electrolyte opening 310 of frame 302). Similarly, electrolyte openings 388 and 390 of frame 382 of element 220, which is coupled to manifolds 530 and 540, respectively, may be coupled to storage tank 122 and flow directed by pump 118. Appropriate connectors such as connectors 542 and 544 direct electrolyte flow from tanks 120 and 122 into the appropriate manifolds formed in stack 201.

As is shown in FIG. 3, frame 342 of each of interior elements such as interior element 212 and interior element 214 is identical, but oppositely oriented by rotation through 180°. Further, battery component 372 of element 212 is a membrane while battery component 372 of element 214 is an electrode. Further, all of interior elements such as interior element 212, where battery component 372 is a membrane, flow one electrolyte across battery element 372 while all of the interior elements such as interior element 214, where battery component 372 is an electrode, flow the opposite electrolyte across battery component 372. As shown in FIG. 3, element 212 is oriented to create a flow field 374 across the right side of battery component 372 of element 212 and element 214 creates a flow field 376 with the opposite electrolyte across the right side of battery component 372 of element 214. Of course, flow field 334 on element 210 is in contact with the left side of battery component 372 of element 212 while flow field 374 of element 212 is in contact with the left side of battery component 372 of element 214. As shown in FIG. 3, elements that include electrodes such as elements 210 and 214 are oriented to form flow field 334 with electrolyte taken from manifold 550 and flowed into manifold 560. Conversely, elements that include membranes such as elements 212 and 218 are oriented to form flow field 374 with electrolyte taken from manifold 530 and flowed into manifold 540.

As can be seen in FIG. 5, electrolyte from tanks 120 and 122 can flow between every alternate frame in stack 201. This can allow anodic and cathodic reactions to occur between every adjacent frame (between two plates separated by an IEM) which can further result in the creation of a potential which can be collected across the end frames 302 and 308 (of end half-cells 202 and 208). In some embodiments, load/source 124 can be coupled across end frames 302 and 308 (of end half-cells 202 and 208).

FIG. 5 illustrates an assembled stack 201. As shown in FIG. 5, elements 210, 212, 213, through 218 and 220 are compressed together between plates 510 and 520. Plates 510 and 520 provide rigidity to stack 201 and may, for example, be formed from metal such as aluminum or stainless steel, for example, or from any other rigid material. The assembly is rigidly held together by threaded rods 570 extended through the through-holes in harnesses 320, 322, 360, 362, 396, and 398, which are all aligned to accommodate rods 570. Electrical lead 580 is electrically coupled to electrode 399 of element 220 and electrical lead 590 is electrically coupled to electrode 332 of element 210. As shown, manifolds 530, 550, 560, and 540 are formed as electrolyte openings 308, 310, 352, 354, 348, 350, 388, and 390 are aligned. Further, fittings 542 and 544 provide access to manifolds 530 and 540 so that electrolyte can flow through tubing 536 and 538 in and out of stack 201. As shown in FIG. 5, flow fields 334 are formed between elements so that the electrolyte entering in tubing 536 exits from tubing 538. Similarly, electrolyte entering through tubing 546 creates flow fields 374 between elements and exits from tubing 548.

As described above, a single frame design can be used for frame 342 utilized in all interior elements such as elements 212, 214, and 218. To form a particular element, either an electrode or a membrane is fixed on frame 342 and the assembly appropriately oriented and positioned in stack 201. Similarly, end frame 302 may be similar if not identical to end frame 382 wherein end frame 302 may be rotated by 180 degrees about its vertical axis and may be used as end frame 382, once channels 304 and 306 have been plugged.

In some embodiments, stack 201 can be constructed between elements 210 and 220 by alternating elements with membranes and elements with electrodes between two end elements, elements 210 and 220. Each interior element is oriented opposite that of the adjacent element by being rotated by 180°. Once positioned, elements 210 through 220 are rigidly coupled by harnesses 320, 322, 360, 362, 396, and 398 that includes any fastening mechanism such as (but not limited to) screws, metal rods or other such harnessing mechanisms.

To aid in assembly of stack 201, some embodiments of harness sections 320, 322, 360, 362, 396, and 398 can include a surface feature prevents adjacent elements from having the same orientation. For example, as shown in FIGS. 4a through 4c, frames 302, 342, and 382 may each include protrusions 372 that align with access holes 374 in such a fashion that, in order to stack elements, the orientation of adjacent elements is alternated. This can help to prevent incorrect assembly of stack 201.

By using a stacked arrangement as discussed above, production costs and complexity for a flow battery consistent with the present disclosure can be reduced because fewer components need to be produced. Moreover, flow battery stacks consistent with the present disclosure may result in fewer possible failure points while mating components together to form a stack.

Other embodiments will be apparent to those skilled in the art from consideration of the specification and practice disclosed herein. It is intended that the specification and examples be considered as exemplary only, with a true scope and spirit of the invention being indicated by the following claims.

What is claimed is:

1. A stack in a flow battery, the stack comprising:
interior elements positioned between two end elements, the two end elements each including an electrode, and the interior elements including membrane elements alternating with electrode elements,
wherein the membrane elements include a membrane bonded to a membrane frame, and the electrode elements include an electrode bonded to an electrode frame, the membrane frame and the electrode frame both being identical interior frames, and
wherein the membrane frame and the electrode frame are positioned such that the membrane frame is rotated by 180° from the electrode frame.

2. The battery stack of claim 1, wherein the interior frame includes electrolyte openings such that a first electrolyte input manifold, a first electrolyte output manifold, a second electrolyte input manifold, and a second electrolyte output manifold are formed in the stack, and
wherein the electrode elements flow a first electrolyte between the first electrolyte input manifold and the first electrolyte output manifold, and
wherein the membrane elements flow a second electrolyte between the second electrolyte input manifold and the second electrolyte output manifold.

3. The battery stack of claim 2, wherein the interior frames include a first flow channel coupled to a first electrolyte opening, and a second flow channel coupled to a second electrolyte opening, the first electrolyte opening and the second electrolyte opening positioned in the stack to flow electrolyte between manifolds.

4. The battery stack of claim 3, wherein the first and second flow channels of any two adjacent interior frames are asymmetric about a vertical axis such that the first and second flow channels of one of the adjacent interior frame flows a first electrolyte between the first electrolyte input manifold and the first electrolyte output manifold, and the first and second flow channels of the other adjacent frame flows a second electrolyte between the second electrolyte input manifold and the second electrolyte output manifold.

5. The battery stack of claim 4, wherein one end element includes an electrode coupled to the interior frame, wherein the second electrolyte input manifold and the second electrolyte output manifold are each sealed with at least one plug.

6. The battery stack of claim 5, wherein an opposite end element includes an electrode coupled to the interior frame, wherein the first electrolyte input manifold and the first electrolyte output manifold are each sealed with the at least one plug, and the first and second flow channels are filled with a sealing.

7. The battery stack of claim 1, wherein the interior frame includes at least one surface feature to prevent incorrect assembly of two adjacent interior frames.

8. The battery stack of claim 7, wherein the at least one surface feature includes at least one protrusion.

9. The battery stack of claim 7, wherein the at least one surface feature includes at least one hole.

10. A method for assembling a stack for use in a flow battery, the method comprising:
assembling two end elements, the two end elements each including an electrode;
assembling membrane elements, the membrane elements each including a membrane bonded to a membrane frame,
assembling electrode elements, the electrode elements each including an electrode bonded to an electrode frame, both the membrane frame and the electrode frame being identical interior frames;
positioning the interior elements between the two end elements with membrane elements alternating with electrode elements and with membrane frames positioned opposite by a rotation of 180° from electrode frames; and
coupling the stack together.

11. The method of claim 10, wherein the membrane includes a porous membrane.

12. The method of claim 10, wherein assembling two end elements includes mounting an electrode assembly to an end frame which is identical with the interior frame.

13. The method of claim 12, wherein the electrode assembly includes at least one terminal.

14. The method of claim 10, wherein coupling each of the odd number of interior elements together with the two end elements includes
aligning interior elements, the interior elements being alternating membrane elements and electrode elements, such that a first surface feature of an interior frame of one element with a second surface feature of an adjacent interior frame of an adjacent element;
coupling all the interior frames to form a first electrolyte input manifold, a first electrolyte output manifold, a second electrolyte input manifold, and a second electrolyte output manifold and wherein membrane frames flow a first electrolyte between the first electrolyte input manifold and the first electrolyte output manifold and wherein electrode frames flow a second electrolyte between the second electrolyte input manifold and the second electrolyte output manifold.

15. The method of claim 14, wherein at least one of the first surface feature or the second surface feature includes at least one hole.

16. The method of claim 14, wherein at least one of the first surface feature or the second surface feature includes at least one protrusion.
